(19) United States
(12) Patent Application Publication
(10) Pub. No.: US 2026/0368170 A1
(43) Pub. Date: Nov. 19, 2026

(54) SYSTEMS AND METHODS FOR TRANSPARENT, PRODUCTION-SAFE POSTGRESQL QUERY REWRITING VIA POST-PARSE ABSTRACT SYNTAX TREE TRANSFORMATION

(71) Applicant: Bert Scalzo, Flower Mound, TX (US)

(72) Inventor: Bert Scalzo, Flower Mound, TX (US)

(21) Appl. No.: 19/731,252

(22) Filed: Jul. 6, 2026

(51) Int. Cl. G06F 16/2453

(52) U.S. Cl. CPC G06F 16/24542

(57) ABSTRACT

A PostgreSQL extension installs transparently between the semantic analyzer and query optimizer via the post_parse_analyze_hook, intercepting SQL traffic without modifying client applications or schemas. For each query, a Query Rewriting Engine walks the Abstract Syntax Tree and extracts structural facts, which a Forward Chaining Inference Engine asserts into working memory and reasons over using production rules drawn from a SQL Rewrite Knowledge Base of anti-patterns and rewrite templates, iteratively firing rules until quiescence so resolving one inefficiency can expose another for detection. The Query Rewriting Engine applies the resulting rewrite actions, producing a structurally improved but equivalent parse tree passed to the unmodified PostgreSQL optimizer and executor. Each query is processed independently, with no state cached across queries. The Knowledge Base is independently extensible without modifying the inference engine. The system benefits both transactional and analytical workloads and is compatible with any PostgreSQL client, driver, or connection pooler.

### CROSS-REFERENCE TO RELATED APPLICATIONS

This application claims the benefit of priority under 35 U.S.C. § 119(e) to U.S. Provisional patent application Ser. No. [______], filed [PROVISIONAL FILING DATE], entitled “SYSTEMS AND METHODS FOR TRANSPARENT, PRODUCTION-SAFE POSTGRESQL QUERY REWRITING VIA POST-PARSE ABSTRACT SYNTAX TREE TRANSFORMATION,” the entire disclosure of which is hereby incorporated by reference in its entirety.

### STATEMENT REGARDING FEDERALLY SPONSORED RESEARCH OR DEVELOPMENT

Not applicable.

### FIELD OF THE INVENTION

The present invention relates to the field of relational database management system (RDBMS) optimization. More specifically, the invention relates to a PostgreSQL extension that installs transparently between the PostgreSQL parser and query optimizer, intercepts each incoming SQL statement immediately following semantic parsing, walks the resulting Abstract Syntax Tree (AST) to identify structural patterns matching a library of rewrite rules, transforms the AST in place into a semantically equivalent but more efficient form, and passes the rewritten query to the standard PostgreSQL optimizer and executor for ordinary processing, without requiring modification to client applications, application schemas, or PostgreSQL configuration beyond installation of the extension. The invention is applicable to any PostgreSQL workload, including online transaction processing (OLTP), online analytical processing (OLAP), hybrid transactional/analytical processing (HTAP), and mixed workloads.

### BACKGROUND OF THE INVENTION

### PostgreSQL Query Execution Pipeline

PostgreSQL processes SQL statements through a multi-stage pipeline comprising: (1) lexical analysis and parsing, which produces a raw parse tree; (2) semantic analysis, which resolves names and produces a Query node tree; (3) query rewriting via PostgreSQL's built-in rule system, used primarily to expand views and apply stored rules; (4) planning and optimization, which produces an execution plan; and (5) execution. Performance-critical decisions are made during stages (3) and (4), yet by the time the query planner receives the query tree, structurally suboptimal patterns are already fixed in the tree representation. The query planner, while capable of sophisticated cost-based optimization, cannot in all cases recover from inefficient query structures established at the parsing stage.

### Limitations of the Prior Art

The prior art suffers from several deficiencies that the present invention addresses.

First, the PostgreSQL query planner operates on the Query node tree as received from the semantic analyzer. While the planner performs cost-based transformations such as join reordering and sub-plan selection, it does not perform deep structural rewrites of the abstract syntax tree, such as subquery unnesting, decorrelation, or view-level predicate pushdown. Queries that reach the planner with structurally inefficient patterns—including deeply nested correlated subqueries, large IN-list predicates, or unflattened common table expression (CTE) chains—frequently produce execution plans that are orders of magnitude slower than plans achievable from a structurally equivalent but differently formed query.

Second, application developers and third-party software vendors routinely generate SQL statements that are semantically correct but structurally suboptimal. Enterprise resource planning (ERP) systems, business intelligence (BI) tools, and object-relational mapping (ORM) frameworks are well-documented sources of such queries, and are well known to reproduce a recurring, catalogable set of structural anti-patterns. Requiring application developers to manually restructure queries is impractical at scale, and is not possible at all where the SQL is generated by third-party software whose source code is inaccessible to the database administrator.

Third, although PostgreSQL exposes extension hook points, including the post_parse_analyze_hook, that permit third-party extensions to intercept and modify query trees, prior art rewriting tools typically apply a fixed, hard-coded set of transformation procedures in a single, non-iterative pass. Such tools cannot detect compound or cascading anti-patterns, in which the resolution of one structural inefficiency exposes or newly satisfies the detection conditions for a second, previously latent inefficiency. Prior art tools likewise do not separate the body of pattern knowledge from the control logic that applies it, such that extending the range of recognized anti-patterns typically requires modifying the underlying reasoning or traversal code itself, rather than merely augmenting a self-contained repository of pattern knowledge.

Fourth, existing extensions and tools that modify query behavior typically require application-level configuration, such as session parameters, connection string hints, or query annotations, rendering them incompatible with third-party applications that generate their own SQL without regard to such configuration. There remains an unmet need for a zero-configuration, transparent solution operable without any change to client applications.

### Need for the Present Invention

There is accordingly a need in the art for a PostgreSQL extension that: (a) transparently interposes itself between the parser and the optimizer without requiring any client-side configuration; (b) performs comprehensive, semantics-preserving, deep rewrites of complex SQL abstract syntax trees on every incoming statement, including compound anti-patterns whose detection depends on the prior detection or resolution of another anti-pattern; (c) draws upon an extensive, organized, and independently extensible body of knowledge concerning known SQL structural anti-patterns and their corresponding efficient rewrite forms; and (d) delivers substantial, and in many cases orders-of-magnitude, performance improvements across both transactional and analytical workloads.

### SUMMARY OF THE INVENTION

The present invention (the “Extension”) is a PostgreSQL shared-library extension comprising four integrated subsystems: a Transparent Interposition Layer, a Query Rewriting Engine, a Forward Chaining Inference Engine, and a SQL Rewrite Knowledge Base.
The Transparent Interposition Layer (“TIL”) registers a hook at the PostgreSQL post_parse_analyze_hook extension point, positioning the Extension between the semantic analyzer and the query optimizer, such that every SQL statement processed by the database server—regardless of its origin—passes through the Extension without modification to any client application or third-party software.
The Query Rewriting Engine (“QRE”) walks each incoming query's Abstract Syntax Tree, extracts a structured set of facts describing the query's structural characteristics, submits those facts to the Forward Chaining Inference Engine, and applies the rewrite actions returned by the Forward Chaining Inference Engine directly to the abstract syntax tree, producing a modified but semantically equivalent parse tree.
The Forward Chaining Inference Engine (“FCIE”) is a production-system-style reasoning engine that performs data-driven, forward-chaining inference over the facts supplied by the Query Rewriting Engine, using production rules drawn from the SQL Rewrite Knowledge Base, iteratively deriving new facts and rewrite actions until no further rule can fire, thereby enabling detection and resolution of compound anti-patterns whose recognition depends on facts derived earlier in the same inference cycle.
The SQL Rewrite Knowledge Base (“KB”) is a structured, categorized, and independently extensible repository of known SQL structural anti-pattern definitions, each paired with one or more corresponding semantically-equivalent efficient rewrite templates, organized to provide the Forward Chaining Inference Engine with a comprehensive and continually extensible source of production rules without requiring modification to the Forward Chaining Inference Engine's reasoning logic.

In a first aspect, the invention provides a method for transparent query optimization comprising: intercepting a SQL query parse tree in a PostgreSQL server at a post-analysis, pre-planning stage via a registered extension hook; walking the parse tree to extract a set of facts describing structural characteristics of the query; asserting the extracted facts into a working memory of a forward chaining inference engine; iteratively matching the asserted facts, and any facts derived therefrom, against a plurality of production rules obtained from a knowledge base of known SQL anti-patterns and corresponding rewrite templates, and firing matching production rules to derive additional facts and to generate rewrite actions, until no further production rule matches the contents of the working memory; applying the generated rewrite actions to the in-memory parse tree, producing a modified Query node tree that is structurally different from, but semantically equivalent to, the original parse tree; and passing the modified parse tree to a standard, unmodified PostgreSQL query optimizer, which thereafter plans, and the database server thereafter executes, the query using ordinary, unmodified PostgreSQL execution machinery.

In a second aspect, the SQL Rewrite Knowledge Base comprises anti-pattern definitions organized into categories including, without limitation, subquery-related anti-patterns, predicate-related anti-patterns, join-related anti-patterns, aggregation-related anti-patterns, and projection and set-operation-related anti-patterns, each definition specifying a pattern signature evaluable against the working memory of the Forward Chaining Inference Engine and one or more corresponding rewrite templates, each rewrite template being independently capable of enabling a performance improvement ranging from approximately two-fold to multiple orders of magnitude, depending on query structure and underlying data distribution.

In a third aspect, each query received by the server is processed independently: the fact extraction, forward-chaining inference, and rewrite-application steps are performed once per incoming statement, and the working memory and any facts or rewrite actions derived during that cycle are discarded after the query completes, with no inference state retained or reused across queries or connections. This per-query processing model eliminates the need for shared cross-session state while still enabling, within the processing of a single query, the cascading detection of compound anti-patterns made possible by the iterative, data-driven nature of the forward chaining inference process.

### BRIEF DESCRIPTION OF THE DRAWINGS

FIG. 1 is a system architecture diagram showing the Extension's four subsystems (the Transparent Interposition Layer, the Query Rewriting Engine, the Forward Chaining Inference Engine, and the SQL Rewrite Knowledge Base) and their positions within the PostgreSQL query execution pipeline, from client connection through the parser, the Extension's interposition point, the planner, the executor, and storage.

FIG. 2 is a flowchart of the per-query execution path through the Extension, illustrating interception of the parse tree, extraction of structural facts by the Query Rewriting Engine, submission of the facts to the Forward Chaining Inference Engine, iterative production-rule firing to a fixed point, application of the resulting rewrite actions to the parse tree, and hand-off of the rewritten parse tree to the unmodified PostgreSQL optimizer.

FIG. 3 is a block diagram of the internal architecture of the Forward Chaining Inference Engine, showing the working memory, the production rule matching component, the conflict resolution component, and the iterative fire-and-assert control loop that proceeds until quiescence is reached.

FIG. 4 is a taxonomy diagram of the SQL Rewrite Knowledge Base, showing its organization into categories of known SQL anti-patterns, including subquery-related, predicate-related, join-related, aggregation-related, and projection and set-operation-related categories, and showing the pairing of each anti-pattern's pattern signature with one or more corresponding rewrite templates.

FIG. 5 is a deployment diagram showing the Extension installed within a PostgreSQL server receiving connections from a plurality of third-party application types, including object-relational mapping frameworks, business intelligence tools, direct SQL clients, and connection poolers, without modification to any such client component.

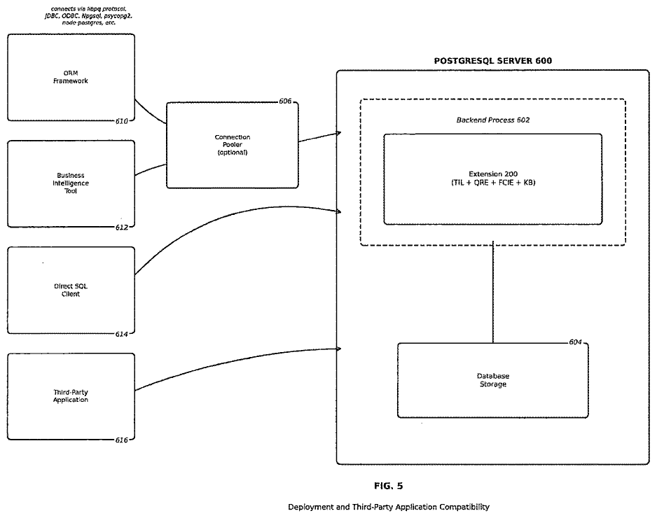

FIG. 6 is a graph illustrating representative query execution time comparisons, with and without the Extension, across query patterns targeted by the Knowledge Base's anti-pattern categories, demonstrating substantial improvement for correlated subquery workloads.

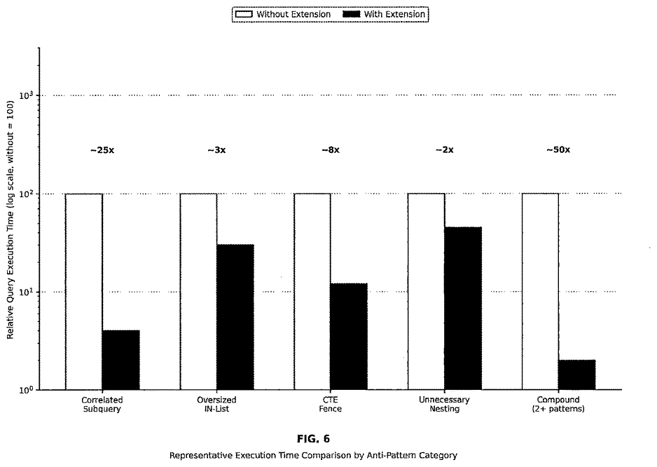

FIG. 7 is a before-and-after abstract syntax tree diagram illustrating a representative correlated subquery being decorrelated into an equivalent lateral join structure through the cooperative operation of the Query Rewriting Engine, the Forward Chaining Inference Engine, and the SQL Rewrite Knowledge Base.

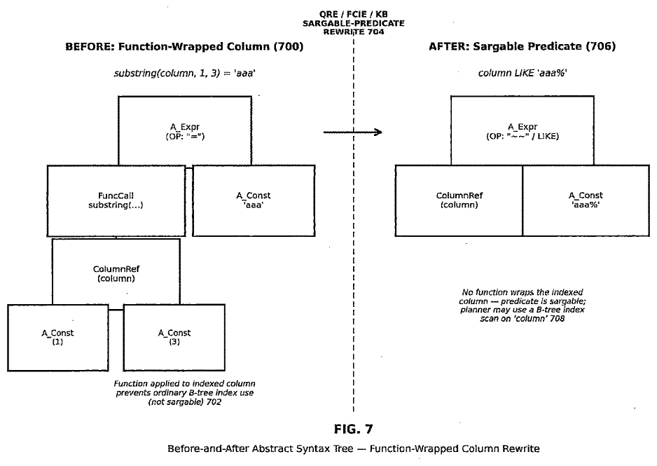

### DETAILED DESCRIPTION OF THE INVENTION

The following detailed description sets forth preferred embodiments of the invention with reference to the accompanying drawings. The embodiments described herein are illustrative and are not intended to limit the scope of the invention, which is defined by the appended claims. Reference to “one embodiment,” “an embodiment,” or similar language means that a particular feature, structure, or characteristic described is included in at least one embodiment of the invention.

### Transparent Interposition Architecture

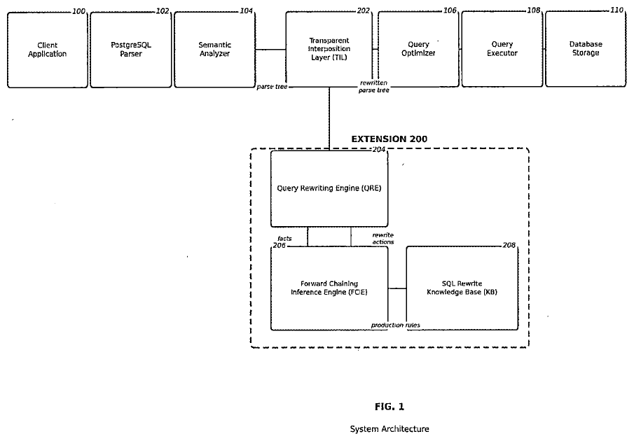

Referring to FIG. 1, the Extension is implemented as a PostgreSQL shared library (a .so file on Linux, a .dll file on Windows, or a .dylib file on macOS) loaded via the shared_preload_libraries configuration parameter. This loading mechanism, native to PostgreSQL, causes the Extension to be initialized in every backend process spawned by the postmaster, ensuring that substantially all query traffic is intercepted regardless of connection source, application type, or client library.

Upon loading, the Extension's initialization function (_PG_init( )) executes an initialization sequence comprising: registering the TIL hook by assigning the Extension's hook function pointer to the post_parse_analyze_hook global variable, while preserving any pre-existing hook via a chained-hook pattern to maintain compatibility with other loaded extensions; registering configuration parameters via the PostgreSQL Grand Unified Configuration (GUC) application programming interface; and initializing the Memory Safety Layer's context-scoped allocation utilities used during per-query AST traversal and rewriting.

The chained-hook pattern is important to third-party application compatibility, in that it ensures the Extension does not disable other extensions, such as query auditing or connection-pooler hooks, that may also register at the same hook point. The TIL invokes any previously registered hook after completing its own processing, thereby preserving the full extension chain.

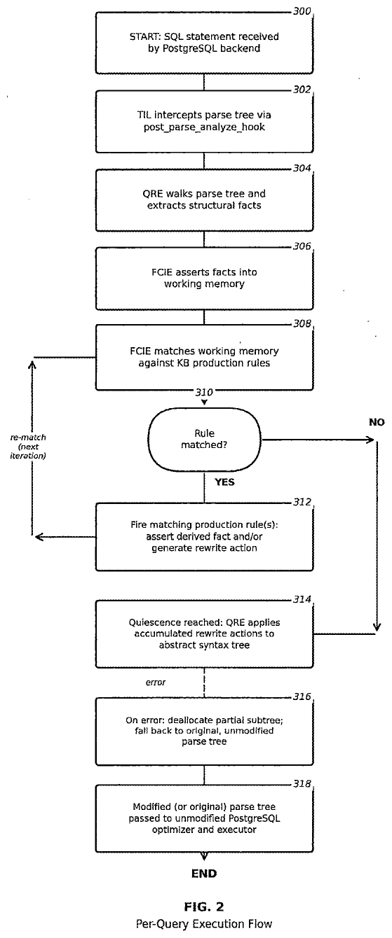

Because interposition occurs at the post_parse_analyze_hook, the Extension operates on the fully semantically analyzed Query node tree before it reaches the query planner. This positioning is architecturally significant in that it permits the Extension to perform structural rewrites unavailable to the planner itself, while furnishing the planner with a well-formed, fully analyzed query tree that the planner may optimize using its complete cost-model machinery. Referring to FIG. 2, after the Extension completes its rewrite of a given statement, control passes to the standard, unmodified PostgreSQL optimizer and executor; the Extension takes no further part in the planning or execution of that statement.

### Query Rewriting Engine

### Per-Query Fact Extraction

For each SQL statement intercepted by the TIL, the Query Rewriting Engine performs a single, self-contained processing cycle. The Query Rewriting Engine first performs a depth-first walk of the incoming Query node tree using PostgreSQL's node-walking infrastructure, including the query_tree_walker and expression_tree_walker functions. During this walk, the Query Rewriting Engine extracts a structured set of facts describing the structural characteristics of the query, including, without limitation, the presence and location of subqueries and their correlation status, the cardinality and content-type of predicate value lists, the reference count and recursive status of common table expressions, the presence of aggregation and grouping constructs, the presence of set operations, and the join structure and predicate placement of the query. Each extracted fact is expressed in a canonical form suitable for matching against production rule conditions.

The Query Rewriting Engine submits the extracted facts to the Forward Chaining Inference Engine described below, and receives in return a set of rewrite actions determined by the Forward Chaining Inference Engine to be applicable to the query. The Query Rewriting Engine then applies each returned rewrite action to the abstract syntax tree, either by mutating the tree in place or by constructing a replacement subtree that is substituted into the parent node, producing a modified Query node tree that is passed to the PostgreSQL query planner.

This process is performed independently for each incoming statement. No fact, rewrite action, or intermediate inference state is retained, cached, or reused across queries. Each query is walked, reasoned over, and rewritten anew, and the transformed Query node tree is passed directly to the PostgreSQL query planner. Because no state is retained between queries, the Query Rewriting Engine requires no cross-session shared memory, no invalidation logic, and no cache-consistency guarantee; correctness is established independently for each statement.

### Applicability to OLTP and OLAP Workloads

The Query Rewriting Engine, operating in cooperation with the Forward Chaining Inference Engine and the SQL Rewrite Knowledge Base, is designed to provide benefit across the full spectrum of PostgreSQL workloads. For OLTP workloads, benefits derive primarily from elimination of correlated subqueries and large IN-lists commonly appearing in application-generated SQL, reducing per-query latency and enabling higher transaction throughput. For OLAP workloads, benefits derive primarily from subquery unnesting, common table expression inlining, aggregate pushdown, and view filter propagation, which collectively enable the planner to generate improved multi-table join plans with more accurate cardinality estimates. Because each query is examined and rewritten independently at the time it is received, the system adapts naturally to schema and data changes between queries without an invalidation mechanism, rendering it suitable for both volatile OLTP schemas and large, slowly changing OLAP data warehouses. The Extension detects workload characteristics, including query complexity, presence of aggregation, and estimated table sizes derived from catalog statistics, at fact-extraction time, and includes such characteristics among the facts submitted to the Forward Chaining Inference Engine so that a beneficial rule subset is selected for each individual query.

### Forward Chaining Inference Engine

### Production-System Architecture

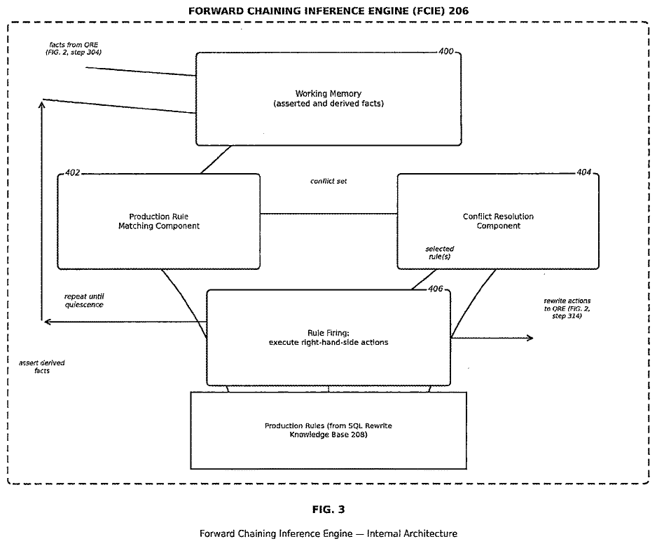

Referring to FIG. 3, the Forward Chaining Inference Engine is a production-system-style reasoning component implementing data-driven, forward-chaining inference. The Forward Chaining Inference Engine maintains a working memory into which the facts extracted by the Query Rewriting Engine are asserted at the start of each query's processing cycle. The Forward Chaining Inference Engine additionally maintains access to a set of production rules, each production rule comprising a left-hand-side condition, evaluated against the contents of the working memory, and a right-hand-side action, executed when the condition is satisfied. Production rules are obtained from the SQL Rewrite Knowledge Base described below, such that each anti-pattern definition in the Knowledge Base is compiled into one or more corresponding production rules for use by the Forward Chaining Inference Engine.

A right-hand-side action of a production rule may take either or both of two forms: the assertion of one or more new, derived facts into the working memory, or the generation of a rewrite action to be returned to the Query Rewriting Engine for application to the abstract syntax tree. The capacity of a production rule to assert new facts, rather than being limited to generating a rewrite action directly, is what permits the Forward Chaining Inference Engine to detect compound or cascading anti-patterns: a fact derived by one production rule's firing may itself satisfy the left-hand-side condition of a second production rule that would not otherwise have matched the facts originally extracted from the query, allowing the Forward Chaining Inference Engine to recognize inefficiencies that only become apparent once an earlier inefficiency has been analyzed or notionally resolved.

### Forward Chaining Control Loop

The Forward Chaining Inference Engine executes an iterative control loop comprising: matching the current contents of the working memory against the left-hand-side conditions of the available production rules to determine a conflict set of production rules whose conditions are satisfied; applying a conflict resolution strategy, based on production rule priority and specificity, to select one or more production rules from the conflict set for firing; executing the right-hand-side actions of the selected production rules, thereby asserting derived facts into the working memory and/or accumulating rewrite actions; and repeating the matching, conflict resolution, and firing steps until a fixed point, referred to as quiescence, is reached, at which no production rule's left-hand-side condition is satisfied by facts not already accounted for in a prior firing of that same production rule. Upon reaching quiescence, the Forward Chaining Inference Engine returns the accumulated set of rewrite actions to the Query Rewriting Engine.

The Forward Chaining Inference Engine applies a refractoriness constraint preventing a given production rule from firing repeatedly on an unchanged set of matching facts, and applies a configurable maximum iteration count to the control loop, preventing non-termination on pathological fact combinations. In one embodiment, the matching step is implemented using an incremental pattern-matching algorithm, such as a Rete-style discrimination network, that avoids re-evaluating production rule conditions against facts that have not changed since the previous iteration, improving the computational efficiency of the forward-chaining process for queries with large numbers of extracted facts.

Because the Forward Chaining Inference Engine's reasoning logic operates solely upon the generic representation of facts and production rules, and does not itself encode any particular SQL anti-pattern, the range of anti-patterns recognized by the system may be extended solely by adding new anti-pattern definitions to the SQL Rewrite Knowledge Base, without modifying the Forward Chaining Inference Engine's control loop, matching algorithm, or conflict resolution strategy.

### SQL Rewrite Knowledge Base

### Knowledge Base Structure

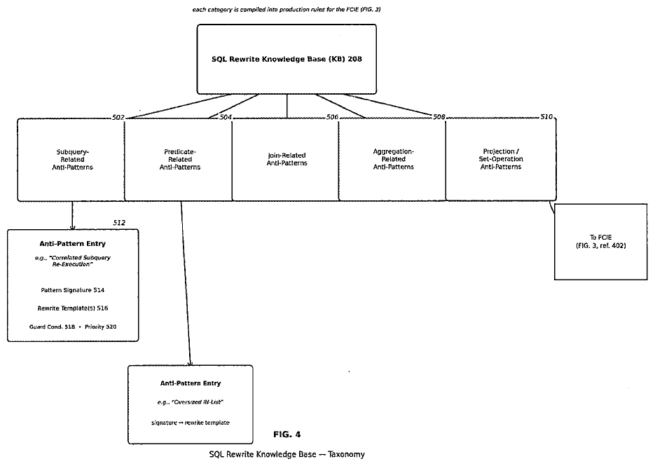

Referring to FIG. 4, the SQL Rewrite Knowledge Base is a structured, categorized repository of definitions of known SQL structural anti-patterns, together with one or more corresponding rewrite templates for each. Each entry in the Knowledge Base comprises: a pattern signature, expressed in terms of the fact vocabulary shared with the Forward Chaining Inference Engine, defining the combination of facts that must be present in working memory for the anti-pattern to be considered detected; one or more rewrite templates, each specifying a parameterized transformation to be applied to the portion of the abstract syntax tree identified by the pattern signature; one or more semantic-preservation guard conditions that must additionally be satisfied before a given rewrite template may be applied to a specific query instance; a set of workload-type tags indicating applicability to OLTP, OLAP, or HTAP workloads; and a priority or estimated cost-reduction value used by the Forward Chaining Inference Engine's conflict resolution strategy.

The Knowledge Base is organized into a plurality of categories of anti-patterns, each addressing a distinct dimension of SQL query structure, including the following representative categories and anti-pattern entries.

### Subquery-Related Anti-Patterns

Correlated Subquery Re-Execution: a correlated subquery appearing in a SELECT list or WHERE clause that is re-evaluated once per outer row, for which the corresponding rewrite template substitutes an equivalent lateral join or semi-join.
Single-Reference CTE Fence: a non-recursive common table expression referenced exactly once in the query body, acting as an unintended barrier to predicate pushdown, for which the corresponding rewrite template inlines the common table expression as a subquery.
Unnecessarily Nested Subquery: a subquery in a FROM clause that could safely be flattened into the parent query's join tree, for which the corresponding rewrite template performs subquery unnesting.
Duplicated Scalar Subquery: the same scalar subquery expression repeated in multiple positions of a query, for which the corresponding rewrite template factors the subquery into a single lateral reference.

### Predicate-Related Anti-Patterns

Oversized IN-List: a predicate of the form column IN (v1, . . . , vN) with a large value list, for which the corresponding rewrite template substitutes an equivalent column=ANY(ARRAY[. . . ]) predicate.
Function-Wrapped Indexed Column: a predicate applying a function to an indexed column, defeating ordinary index use, for which the corresponding rewrite template, where semantically safe, restructures the predicate to isolate the indexed column or recommends an equivalent expression-index-compatible form.
Implicit Type Coercion on Indexed Column: a predicate comparing an indexed column to a literal or parameter of a different data type, causing an implicit cast that defeats index use, for which the corresponding rewrite template substitutes an explicitly and correctly typed literal or parameter.
Leading-Wildcard Pattern Match: a LIKE or ILIKE predicate with a leading wildcard, preventing ordinary B-tree index use, for which the corresponding rewrite template flags the predicate for trigram or full-text index guidance where such an index is present.
Cross-Column OR Predicate: a disjunction of predicates over two or more differently indexed columns, preventing a single-index-scan plan, for which the corresponding rewrite template substitutes an equivalent UNION ALL of simpler queries.
Nullable-Column NOT IN Subquery: a NOT IN predicate against a subquery that may return a null value, presenting both a correctness hazard and an unindexable plan, for which the corresponding rewrite template substitutes a NOT EXISTS formulation that preserves correct null-handling semantics while enabling anti-join execution.

### Join-Related Anti-Patterns

Implicit Cross Join: a comma-separated FROM list lacking a corresponding join predicate, producing an unintended Cartesian product, for which the corresponding rewrite template flags the construct and, where an equivalent join predicate can be inferred from surrounding WHERE-clause conditions, restructures the query as an explicit join.
Eliminable Self-Join: a self-join of a table against itself that can be replaced by a window function or aggregate expression, for which the corresponding rewrite template substitutes the equivalent window-function or aggregate form.
Late Predicate Placement: a filter predicate placed such that it is applied only after a costly join, where the predicate could instead be evaluated earlier, for which the corresponding rewrite template relocates the predicate via join predicate pushdown.

### Aggregation-Related Anti-Patterns

Unpushed Aggregate Filter: an aggregate computed over an unfiltered subquery where an outer filter could instead be pushed into the subquery prior to aggregation, for which the corresponding rewrite template performs aggregate pushdown.
Redundant Grouping Column: a GROUP BY clause including a column already functionally determined by another grouping column or a unique constraint, for which the corresponding rewrite template removes the redundant grouping column.

### Projection and Set-Operation Anti-Patterns

Redundant DISTINCT: a DISTINCT clause that is provably redundant given the query's join structure and applicable unique constraints, for which the corresponding rewrite template removes the DISTINCT clause.
Unnecessary UNION Deduplication: a UNION operator used to combine result sets that are already known to be disjoint or for which duplicate elimination is not required by the query's semantics, for which the corresponding rewrite template substitutes the less costly UNION ALL operator.
Premature ORDER BY: an ORDER BY clause applied to an intermediate result that is subsequently subjected to a set operation or aggregation that does not preserve or require that ordering, for which the corresponding rewrite template removes the premature sort.

### Extensibility

New anti-pattern definitions may be added to the SQL Rewrite Knowledge Base, and existing definitions may be revised, independently of the Forward Chaining Inference Engine's reasoning logic and independently of the Transparent Interposition Layer's interception mechanism, because the Knowledge Base is consulted by the Forward Chaining Inference Engine solely through the shared fact vocabulary and the generic pattern-signature and rewrite-template structure described above. In one embodiment, the Knowledge Base is distributed as a versioned, updatable data file or compiled module separate from the Forward Chaining Inference Engine's executable logic, such that the range of anti-patterns recognized by an installed Extension may be expanded through an update to the Knowledge Base component alone.

### Third-Party Application Compatibility

The transparent interposition architecture is compatible with any third-party application communicating with PostgreSQL using the standard libpq protocol, or any driver built thereon, including without limitation JDBC, ODBC, Npgsql, psycopg2, node-postgres, the Ruby pg gem, the Go pq driver, and PHP's PostgreSQL extension. The Extension imposes no requirement on client applications: no special query annotation is required, no connection-string parameter must be set, no application code must be modified, and no schema change is required.

The Extension is further compatible with PostgreSQL connection poolers, including PgBouncer, Pgpool-II, and Odyssey, because it operates entirely within the PostgreSQL backend process following connection establishment and performs no cross-connection state retention. From the perspective of a connection pooler, a backend process executing the Extension behaves identically to an unmodified PostgreSQL backend. The Extension is compatible with PostgreSQL logical replication because it does not modify the write-ahead log and does not alter the schema of any user table. The Extension is compatible with PostgreSQL streaming replication because it performs its rewrite independently on each backend process, for each query, with no state of any kind shared or replicated between servers.

### Error Handling and Memory Management

Fact extraction, forward-chaining inference, and rewrite-application operations are performed within PostgreSQL's structured exception-handling construct (PG_TRY/PG_CATCH). If an error occurs during any of these operations, for example upon encountering an unexpected node type during fact extraction or rewrite application, any partially constructed replacement subtree is deallocated via a recursive freeing utility implemented by the Extension, and the original, unmodified query tree is passed to the PostgreSQL query planner, thereby preserving correctness and production safety at the cost of a single missed optimization opportunity, rather than resulting in a server crash. All working-memory facts, derived facts, and abstract syntax tree structures created during a query's fact-extraction and inference cycle are allocated within the PostgreSQL per-query memory context active at the time the post_parse_analyze_hook is invoked, and are automatically released when PostgreSQL deletes that memory context at the conclusion of query processing, in accordance with ordinary PostgreSQL memory management practice, without requiring cross-query or cross-session memory management.

### Configuration Parameters

The Extension exposes a plurality of configuration parameters, settable in the PostgreSQL configuration file, via the ALTER SYSTEM command, or on a per-session basis via the SET command, including the following.
An enable/disable parameter (default: enabled) that, when disabled, causes the Transparent Interposition Layer to pass all queries through unmodified.
A category-selection parameter (default: all categories enabled) accepting a comma-separated list of SQL Rewrite Knowledge Base anti-pattern category identifiers, or a predefined subset corresponding to OLTP-or OLAP-optimized workloads.
A knowledge base version parameter identifying the version of the SQL Rewrite Knowledge Base currently loaded, permitting independent versioning and update of the Knowledge Base component.
A logging parameter (default: disabled) that, when enabled, logs each production rule firing, the anti-pattern detected, and the estimated improvement factor of the resulting rewrite.
A maximum recursion depth parameter (default: one hundred) limiting abstract syntax tree traversal depth during fact extraction, to prevent stack overflow on pathologically deep query trees.
A maximum inference iteration count parameter (default: fifty) limiting the number of forward-chaining control-loop iterations applied to a single query, to prevent non-termination on unusual fact combinations.

### Performance Characteristics

The performance characteristics described in this section are expected based on the architectural design of the Extension; specific numerical results will vary depending on hardware, data distribution, table size, and query complexity.
Correlated subquery decorrelation: queries containing correlated subqueries over large tables commonly exhibit scaling proportional to outer table row count. Decorrelation converts such queries into hash-join plans, yielding performance improvements that may exceed one thousand-fold for tables containing millions of rows.
IN-list to ANY conversion: queries containing IN-lists of hundreds to thousands of values, common in queries generated by object-relational mapping frameworks, benefit from index-based array scanning, with typical improvements ranging from approximately two-fold to twenty-fold.
Common table expression inlining: queries using common table expressions as optimization fences that prevent predicate pushdown benefit from inlining, with typical improvements ranging from approximately two-fold to fifty-fold, depending on the selectivity of the pushed predicate.
Subquery unnesting: queries using subqueries in FROM clauses that prevent join reordering benefit from unnesting by exposing the full join plan search space to the optimizer, with typical improvements ranging from approximately one-and-one-half-fold to ten-fold.
Compound anti-pattern resolution: queries exhibiting two or more interacting anti-patterns, such as a correlated subquery whose decorrelation exposes a further-eliminable redundant DISTINCT clause, benefit from the cascading detection enabled by the Forward Chaining Inference Engine's iterative control loop, achieving a combined improvement exceeding the improvement achievable by resolving either anti-pattern in isolation.

Because each query is processed anew, without a caching layer, the fact extraction and forward-chaining inference pass adds a bounded amount of processing time per query, typically on the order of low-single-digit milliseconds or less for common query shapes even accounting for multiple inference iterations. For the classes of queries targeted by the Knowledge Base, this overhead is, for the overwhelming majority of such queries, substantially outweighed by the downstream execution-time savings achieved by the rewrite. This favorable overhead-to-benefit ratio holds independent of the number of queries previously processed by a given backend process, because no state is carried forward between queries.

What is claimed is:

1. A system for transparent PostgreSQL query optimization, comprising: a Transparent Interposition Layer configured to register a hook at a PostgreSQL post_parse_analyze_hook extension point such that every SQL query parse tree processed by a PostgreSQL server passes through the system between a semantic analyzer and a query planner without modification to any client application; a Query Rewriting Engine configured to walk each incoming query parse tree to extract a set of facts describing structural characteristics of the query, and to apply, to the query parse tree, one or more rewrite actions to produce a modified parse tree; a Forward Chaining Inference Engine configured to receive the set of facts from the Query Rewriting Engine, to assert the set of facts into a working memory, to iteratively match contents of the working memory against a plurality of production rules and fire matching production rules to derive additional facts and generate the one or more rewrite actions, and to return the one or more rewrite actions to the Query Rewriting Engine upon reaching a fixed point at which no further production rule matches the contents of the working memory; and a SQL Rewrite Knowledge Base storing a plurality of SQL anti-pattern definitions, each anti-pattern definition comprising a pattern signature and a corresponding rewrite template, from which the plurality of production rules used by the Forward Chaining Inference Engine are derived; wherein the modified parse tree is passed to an unmodified PostgreSQL query optimizer for planning and to a PostgreSQL executor for execution.

2. The system of claim 1, wherein at least one production rule of the plurality of production rules is configured, upon firing, to assert a derived fact into the working memory that satisfies a condition of a second production rule not satisfied by the set of facts originally received from the Query Rewriting Engine, thereby enabling the Forward Chaining Inference Engine to detect a compound anti-pattern dependent on the derived fact.

3. The system of claim 1, wherein the Forward Chaining Inference Engine is further configured to apply a conflict resolution strategy, based on a priority value and a specificity value associated with each production rule, to select a production rule for firing from among a plurality of production rules whose conditions are simultaneously satisfied by the contents of the working memory.

4. The system of claim 1, wherein each anti-pattern definition in the SQL Rewrite Knowledge Base further comprises a semantic-preservation guard condition, and wherein a production rule derived from the anti-pattern definition generates a rewrite action only when the semantic-preservation guard condition is satisfied for a specific query instance.

5. The system of claim 1, wherein the plurality of SQL anti-pattern definitions is organized into a plurality of categories comprising subquery-related anti-patterns, predicate-related anti-patterns, join-related anti-patterns, aggregation-related anti-patterns, and projection and set-operation-related anti-patterns.

6. The system of claim 1, wherein the SQL Rewrite Knowledge Base is configured to be extended with an additional anti-pattern definition without modification to a reasoning logic, a matching algorithm, or a conflict resolution strategy of the Forward Chaining Inference Engine.

7. The system of claim 1, wherein the Transparent Interposition Layer is configured to preserve compatibility with other PostgreSQL extensions by implementing a chained-hook pattern that invokes a previously registered post_parse_analyze_hook after completing processing by the Transparent Interposition Layer.

8. The system of claim 1, wherein the Query Rewriting Engine is configured to process each incoming query parse tree independently, such that no fact, rewrite action, or working-memory state computed for one query is retained, cached, or reused in processing another query.

9. The system of claim 1, wherein the system is configured to operate with a client application communicating with PostgreSQL via a libpq protocol or a driver built thereon, without modification to client application source code, query text, connection parameters, or database schema.

10. The system of claim 1, wherein the set of facts extracted by the Query Rewriting Engine includes a workload-characteristic fact, and wherein a production rule of the plurality of production rules generates a rewrite action conditioned upon the workload-characteristic fact indicating an online transaction processing workload or an online analytical processing workload, such that the system provides a performance improvement for both workload types.

11. A method for transparent, production-safe PostgreSQL query optimization, comprising: loading a PostgreSQL shared-library extension via a shared_preload_libraries mechanism; registering a hook at a post_parse_analyze_hook extension point to intercept each query parse tree prior to planning; for each intercepted query, walking the parse tree to extract a set of facts describing structural characteristics of the query; asserting the set of facts into a working memory of a forward chaining inference engine; iteratively matching contents of the working memory against a plurality of production rules obtained from a knowledge base of SQL anti-pattern definitions and corresponding rewrite templates, and firing a matching production rule to derive an additional fact or to generate a rewrite action, until no further production rule matches the contents of the working memory; applying the generated rewrite action to an in-memory parse tree to produce a modified parse tree that is structurally different from, but semantically equivalent to, an original parse tree; and passing the modified parse tree to an unmodified PostgreSQL query optimizer, which plans, and a PostgreSQL executor thereafter executes, the query using unmodified execution machinery.

12. The method of claim 10, wherein firing a matching production rule comprises deriving an additional fact that satisfies a condition of a second production rule not satisfied by the set of facts extracted from the parse tree, and further comprising firing the second production rule to generate a further rewrite action, thereby detecting and resolving a compound anti-pattern within a single processing cycle for the query.

13. The method of claim 10, further comprising: detecting an error occurring during the walking, matching, or applying steps; responsive to detecting the error, deallocating a partially constructed replacement subtree; and passing an original, unmodified parse tree to the unmodified PostgreSQL query optimizer.

14. The method of claim 10, wherein the walking, asserting, matching, firing, and applying steps are performed independently for each query received by the PostgreSQL server, without retaining, caching, or reusing a fact or a rewrite action computed for a previously processed query.

15. The method of claim 10, further comprising extending the knowledge base of SQL anti-pattern definitions with an additional anti-pattern definition without modifying a control loop or a matching algorithm of the forward chaining inference engine.

16. A non-transitory computer-readable medium storing instructions that, when loaded and executed as a PostgreSQL shared-library extension by one or more processors, cause the one or more processors to implement the system of claim 1.
